(19) United States
(12) Patent Application Publication
(10) Pub. No.: US 2019/0302783 A1
(43) Pub. Date: Oct. 3, 2019

(54) SYSTEM AND METHOD FOR AUTONOMOUS WORK VEHICLE OPERATIONS

(71) Applicants: Autonomous Solutions, Inc., Mendon, UT (US); CNH Industrial America LLC, New Holland, PA (US)

(72) Inventors: Daniel John Morwood, Petersboro, UT (US); Bret Todd Turpin, Wellsville, UT (US); Walter Gunter, Mendon, UT (US); Matt Droter, Mendon, UT (US)

(21) Appl. No.: 15/940,312

(22) Filed: Mar. 29, 2018

(51) Int. Cl. G05D 1/02; G05D 1/00

(52) U.S. Cl. CPC G05D 1/0219; G05D 2201/0202; G05D 1/0274; G05D 1/0088

(57) ABSTRACT

A control system of a work vehicle system includes a controller that includes a memory and a processor. The controller is configured to determine a route from a current location of a work vehicle to a destination based, at least in part, on a map of a work area. Further, the controller is configured to output one or more control instructions indicative of a travel path for the work vehicle from the current location to a target object at the destination. In addition, the controller is configured to determine whether the route includes one or more obstacles not included on the map of the work area based, at least in part, on a first signal received from a sensor assembly. Moreover, the controller is configured to determine a final approach to a target location near or at the target object at the destination based, at least in part, on a second signal received from the sensor assembly

### BACKGROUND

The present disclosure relates generally to a system and method for autonomous work vehicle operations.

Work vehicles (e.g., tractors, tow-vehicles, self-propelled implements, self-propelled air-carts, etc.) may perform various operations in a work area. For example, the work vehicles may park in stalls, couple to attachments (e.g., implements, front loaders, etc.), couple to nurse vehicles (e.g., a truck that refills a consumable such as fuel, fertilizer, seed, electric charge, etc.), etc. For autonomous operation, a map of the work area may not have sufficient detail to enable the work vehicle to autonomously perform the operations listed above.

### BRIEF DESCRIPTION

In one embodiment, a control system of a work vehicle system includes a controller that includes a memory and a processor. The controller is configured to determine a route from a current location of a work vehicle to a destination based, at least in part, on a map of a work area. Further, the controller is configured to output one or more control instructions indicative of a travel path for the work vehicle from the current location to a target object at the destination. In addition, the controller is configured to determine whether the route includes one or more obstacles not included on the map of the work area based, at least in part, on a first signal received from a sensor assembly. Moreover, the controller is configured to determine a final approach to a target location near or at the target object at the destination based, at least in part, on a second signal received from the sensor assembly.

In another embodiment, a method for autonomously controlling a work vehicle includes determining, via a controller, a route from a current location of a work vehicle to a destination based, at least in part, on a map of a work area. The method further includes outputting, via the controller, one or more control instructions indicative of a travel path for the work vehicle from the current location to a target object at the destination. In addition, the method includes determining, via the controller, whether the route includes one or more obstacles not included on the map of the work area based, at least in part, on a first signal received from a sensor assembly. Moreover, the method includes determining, via the controller, a final approach to a target location near or at the target object at the destination based, at least in part, on a second signal received from the sensor assembly.

In a further embodiment, one or more tangible, non-transitory, machine-readable media comprising instructions configured to cause a processor to determine a route from a current location of a work vehicle to a destination based, at least in part, on a map of a work area. The instructions are further configured to cause the processor to output one or more control instructions indicative of a travel path for the work vehicle from the current location to a target object at the destination. In addition, the instructions are configured to cause the processor to determine whether the route includes one or more obstacles not included on the map of the work area based, at least in part, on a first signal received from a sensor assembly. Moreover, the instructions are configured to cause the processor to determine a final approach to a target location near or at the target object at the destination based, at least in part, on a second signal received from the sensor assembly.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an embodiment of a work vehicle within a work area;

FIG. 2 is a schematic diagram of an embodiment of a control system that may be utilized to control the work vehicle of FIG. 1; and

FIG. 3 is a flowchart of an embodiment of a process for controlling the work vehicle of FIG. 1.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

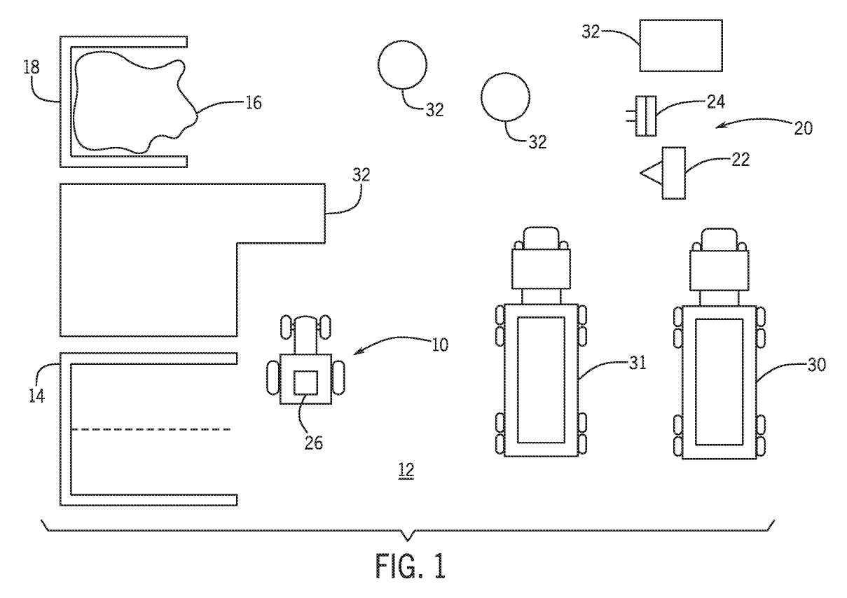

FIG. 1 is a schematic diagram of an embodiment of a work vehicle 10 in a work area 12. The work vehicle 10 (e.g., skid steer, tractor, harvester, or other prime mover) may travel through the work area 12 to perform various tasks. For example, the work vehicle 10 may park in a parking stall 14, gather material 16 (e.g., agricultural material such as fertilizer or seed, construction material such as earthen materials, or any other suitable material that may be used for an industrial application) from a material stall 18, couple to attachments 20 (e.g., an implement 22, a front loader 24, or any other type of attachment suitable for a work vehicle), couple to a nurse truck 30 (e.g., a vehicle that may provide material (such as, fuel, fertilizer, seeds, or any other suitable material) to the work vehicle 10), offload material (e.g., the material 16, agricultural material such as fertilizer or seed, construction material such as earthen materials, or any other suitable material that may be used for an industrial application) into a material receptacle 31 (e.g., a vehicle that may receive and carry material from one location to another), or a combination thereof. Further, in the present embodiment, the material receptacle 31 is part of a work vehicle that may be mobile. In some embodiments, the material receptacle 31 may be in a fixed location, such as a hopper, material silo, etc.

In the present embodiment, the work vehicle 10 may perform these tasks autonomously or semi-autonomously. Further, the work vehicle 10 includes one or more obstacle avoidance systems that enable the work vehicle 10 to detect and avoid obstacles. For example, a first obstacle avoidance system of the work vehicle 10 may include a map of the work area 12 that may be two-dimensional and may include some or all of the objects to avoid. For example, the objects may include the parking stall 14, the material stall 18, the attachments 20, the nurse truck 30, the material receptacle 31, other obstacles 32, or a combination thereof. Further, the first obstacle avoidance system may direct the work vehicle 10 to maintain a certain distance (e.g., one meter, two meters, three meters, or any other suitable distance) from an object.

However, as discussed above, the work vehicle 10 may interact with certain objects in the work area 12. As such, a second obstacle avoidance system may be utilized to enable the work vehicle to approach objects that the first obstacle system would direct the work vehicle to avoid. In doing so, the second obstacle avoidance system may take priority over the first obstacle avoidance system. For example, the work vehicle includes a vehicle control system 26 that may enable the work vehicle 10 to detect, (e.g., in real-time, in near real-time, etc.) objects that are proximate to the work vehicle 10. Further, the vehicle control system 26 may detect the distance between the work vehicle 10 and a proximate object such that the work vehicle 10 may approach the object, or even couple to the object. For example, as the work vehicle 10 approaches an object, the data from the second obstacle avoidance system may have a higher priority than the data from the first obstacle avoidance system. As such, when the work vehicle 10 approaches an object for docking, the data from the first obstacle avoidance system may be ignored in favor of the data from the second obstacle avoidance system. Further, the vehicle control system may include the first obstacle avoidance system, the second obstacle avoidance system, or both.

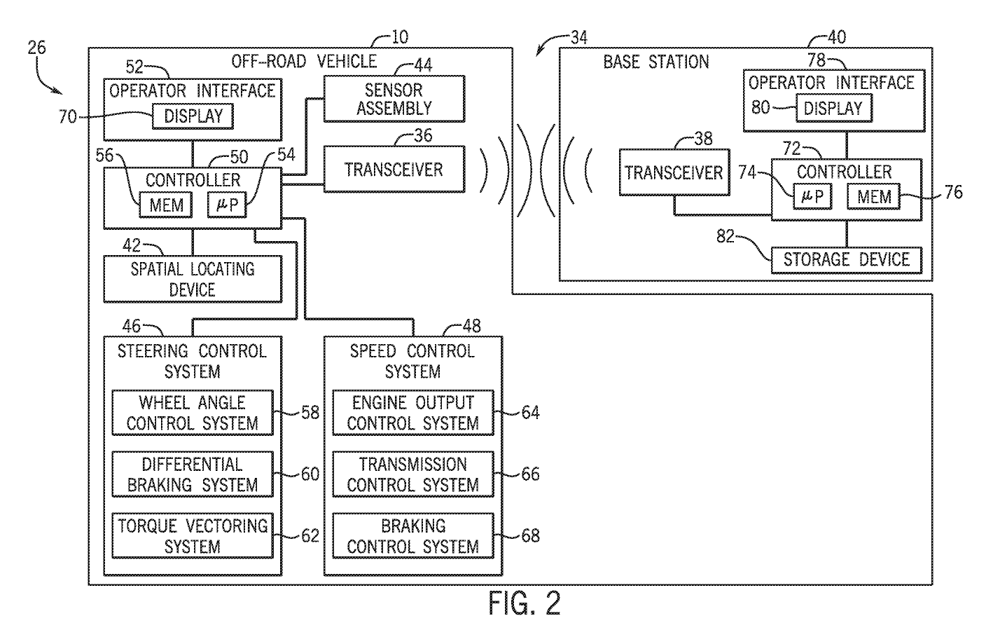

FIG. 2 is a schematic diagram of an embodiment of a control system 34 that may be utilized to control the work vehicle 10 of FIG. 1. In the illustrated embodiment, the control system 34 includes the vehicle control system 26 (e.g., mounted on the work vehicle 10), and the vehicle control system 26 includes a first transceiver 36 configured to establish a wireless communication link with a second transceiver 38 of a base station 40. The first and second transceivers may operate at any suitable frequency range within the electromagnetic spectrum. For example, in certain embodiments, the transceivers may broadcast and receive radio waves within a frequency range of about 1 GHz to about 10 GHz. In addition, the first and second transceivers may utilize any suitable communication protocol, such as a standard protocol (e.g., Wi-Fi, Bluetooth, etc.) or a proprietary protocol. In other embodiments, the base station 40 may be omitted, and components of the base station 40 may also be omitted or distributed among the work vehicle control system and any other suitable control system.

In the illustrated embodiment, the vehicle control system 26 includes a spatial locating device 42, which is mounted to the work vehicle 10 and configured to determine a position of the work vehicle 10. The spatial locating device may include any suitable system configured to determine the position of the work vehicle, such as a global positioning system (GPS) receiver, for example. In certain embodiments, the spatial locating device 42 may be configured to determine the position of the work vehicle relative to a fixed point within the field (e.g., via a fixed radio transceiver). Accordingly, the spatial locating device 42 may be configured to determine the position of the work vehicle relative to a fixed global coordinate system (e.g., via the GPS) or a fixed local coordinate system. In certain embodiments, the first transceiver 36 is configured to broadcast a signal indicative of the position of the work vehicle 10 to the second transceiver 38 of the base station 40. Using the position of the work vehicle 10 during traversal of the work area 12, a map of the work area may be generated. The map may enable the first obstacle avoidance system to determine the position of an obstacle before the sensors of the first obstacle avoidance system can detect the obstacle. For example, as the work vehicle 10 or a scouting vehicle travels around a portion of the work area, the control system 34 may generate a map of the work area by utilizing sensors on the work vehicle 10 or the scouting vehicle to detect the positions obstacles in the work area and adding the positions of the obstacles to a map of the work area. Further, the sensors may additionally detect a shape, size, dimension, etc. of the obstacles in the work area. Additionally or alternatively, a map may be updated during operation of the work vehicle 10. The map may include locations of objects to be avoided.

In addition, the vehicle control system 26 includes a sensor assembly 44. In certain embodiments, the sensor assembly is configured to facilitate determination of condition(s) of the work vehicle 10 and/or the work area 12. For example, the sensor assembly 44 may include multiple sensors (e.g., infrared sensors, ultrasonic sensors, magnetic sensors, radar sensors, Lidar sensors, terahertz sensors, etc.) configured to monitor a rotation rate of a respective wheel or track and/or a ground speed of the work vehicle. The sensors may also monitor operating levels (e.g., temperature, fuel level, etc.) of the work vehicle 10. Furthermore, the sensors may monitor conditions in and around the work area, such as temperature, weather, wind speed, humidity, and other conditions. In addition, the sensors may detect physical objects in the work area, such as the parking stall, the material stall, accessories, other vehicles, other obstacles, or other object(s) that may in the area surrounding the work vehicle. Further, the sensor assembly 44 may be utilized by the first obstacle avoidance system, the second obstacle avoidance system, or both.

In the illustrated embodiment, the work vehicle 10 includes a movement control system that includes a steering control system 46 configured to control a direction of movement of the work vehicle 10 and a speed control system 48 configured to control a speed of the work vehicle 10. The vehicle control system 26 includes a vehicle controller 50 communicatively coupled to the first transceiver 36, the spatial locating device 42, the sensor assembly 44, and an operator interface 52. In certain embodiments, the vehicle controller 50 is configured to receive a location of the work vehicle 10 and to instruct the vehicle to move based at least in part on the location of the work vehicle 10. Further, the vehicle controller 50 may receive a task to be completed for the work vehicle 10 and create a plan that includes a route for the work vehicle 10 to follow.

In certain embodiments, the vehicle controller 50 is an electronic controller having electrical circuitry configured to process data from the first transceiver 36, the spatial locating device 42, the sensor assembly 44, or a combination thereof, among other components of the work vehicle 10. In the illustrated embodiment, the vehicle controller 50 includes a processor, such as the illustrated microprocessor 54, and a memory device 56. The vehicle controller 50 may also include one or more storage devices and/or other suitable components. The microprocessor 54 may be used to execute software, such as software for controlling the work vehicle 10, and so forth. Moreover, the microprocessor 54 may include multiple microprocessors, one or more “general-purpose” microprocessors, one or more special-purpose microprocessors, and/or one or more application specific integrated circuits (ASICS), or some combination thereof. For example, the microprocessor 54 may include one or more reduced instruction set (RISC) processors.

The memory device 56 may include a volatile memory, such as random access memory (RAM), and/or a nonvolatile memory, such as read-only memory (ROM). The memory device 56 may store a variety of information and may be used for various purposes. For example, the memory device 56 may store processor-executable instructions (e.g., firmware or software) for the microprocessor 54 to execute, such as instructions for controlling the work vehicle 10. The storage device(s) (e.g., nonvolatile storage) may include ROM, flash memory, a hard drive, or any other suitable optical, magnetic, or solid-state storage medium, or a combination thereof. The storage device(s) may store data (e.g., field maps), instructions (e.g., software or firmware for controlling the work vehicle, etc.), and any other suitable data.

In the illustrated embodiment, the steering control system 46 includes a wheel angle control system 58, a differential braking system 60, and a torque vectoring system 62. The wheel angle control system 58 may automatically rotate one or more wheels or tracks of the work vehicle (e.g., via hydraulic actuators) to steer the work vehicle along a path through the work area (e.g., around mapped objects in the work area). By way of example, the wheel angle control system 58 may rotate front wheels/tracks, rear wheels/tracks, and/or intermediate wheels/tracks of the work vehicle, either individually or in groups. The differential braking system 60 may independently vary the braking force on each lateral side of the work vehicle to direct the work vehicle along the path through the field. Similarly, the torque vectoring system 62 may differentially apply torque from the engine to wheels and/or tracks on each lateral side of the work vehicle, thereby directing the work vehicle along the path through the field. While the illustrated steering control system 46 includes the wheel angle control system 58, the differential braking system 60, and the torque vectoring system 62, it should be appreciated that alternative embodiments may include one or more of these systems, in any suitable combination. Further embodiments may include a steering control system 46 having other and/or additional systems to facilitate directing the work vehicle through the work area (e.g., an articulated steering system, etc.).

In the illustrated embodiment, the speed control system 48 includes an engine output control system 64, a transmission control system 66, and a braking control system 68. The engine output control system 64 is configured to vary the output of the engine to control the speed of the work vehicle 10. For example, the engine output control system 64 may vary a throttle setting of the engine, a fuel/air mixture of the engine, a timing of the engine, and/or other suitable engine parameters to control engine output, or a combination thereof. In addition, the transmission control system 66 may adjust an input-output ratio within a transmission to control the speed of the work vehicle. Furthermore, the braking control system 68 may adjust braking force, thereby controlling the speed of the work vehicle 10. While the illustrated speed control system 48 includes the engine output control system 64, the transmission control system 66, and the braking control system 68, it should be appreciated that alternative embodiments may include one or two of these systems, in any suitable combination. Further embodiments may include a speed control system 48 having other and/or additional systems to facilitate adjusting the speed of the work vehicle.

In the illustrated embodiment, the work vehicle 10 includes an operator interface 52 communicatively coupled to the vehicle controller 50. The operator interface 52 is configured to present data from one or more work vehicles to an operator (e.g., data associated with objects surrounding the work vehicle(s), data associated with the types of the objects surrounding the work vehicle(s), data associated with operation of the work vehicle(s), data associated with the plan of the work vehicle(s), etc.). The operator interface 52 may also enable the user to input information about the work area and/or the plan that may enable the vehicle controller 50 to determine further courses of action for the work vehicle. The operator interface 52 is also configured to enable an operator to control certain functions of the work vehicle(s) (e.g., starting and stopping the work vehicle(s), instructing the work vehicle(s) to follow a route through the work area, etc.). In the illustrated embodiment, the operator interface 52 includes a display 70 configured to present information to the operator, such as the position of the work vehicle(s) within the field, the speed of the work vehicle(s), and the path(s) of the work vehicle(s), among other data. The display 70 may be configured to receive touch inputs, and/or the operator interface 52 may include other input device(s), such as a keyboard, mouse, or other human-to-machine input devices. In addition, the operator interface 52 (e.g., via the display 70, via an audio system, etc.) is configured to notify the operator of the plan and/or travel path of the work vehicle.

As previously discussed, the vehicle control system 26 is configured to communicate with the base station 40 via the first transceiver 36 and the second transceiver 38. In the illustrated embodiment, the base station 40 includes a base station controller 72 communicatively coupled to the second transceiver 38. The base station controller 72 is configured to output commands and/or data to the work vehicle 10. For example the base station controller 72 may be configured to determine a map of the work area (e.g., including objects that may impede a path of the work vehicle, etc.) and/or the route of the work vehicle through the work area. The base station controller 72 may then output instructions indicative of the route of the work vehicle to the vehicle controller 50, thereby enabling the vehicle controller 50 to direct the work vehicle 10 though the work area. In some embodiments, the base station controller may determine the route based on the plan, the map of the work area, and the position work vehicle 10. In some embodiments, the base station controller 72 outputs a plan and the vehicle controller determines the route based on the received plan, the map of the work area, and the position of the work vehicle 10. In addition, the base station controller 72 may output start and stop commands to the vehicle controller 50.

In certain embodiments, the base station controller 72 is an electronic controller having electrical circuitry configured to process data from certain components of the base station 40 (e.g., the second transceiver 38). In the illustrated embodiment, the base station controller 72 includes a processor, such as the illustrated microprocessor 74, and a memory device 76. The processor 74 may be used to execute software, such as software for providing commands and/or data to the base station controller 72, and so forth. Moreover, the processor 74 may include multiple microprocessors, one or more “general-purpose” microprocessors, one or more special-purpose microprocessors, and/or one or more application specific integrated circuits (ASICS), or some combination thereof. For example, the processor 74 may include one or more reduced instruction set (RISC) processors. The memory device 76 may include a volatile memory, such as RAM, and/or a nonvolatile memory, such as ROM. The memory device 76 may store a variety of information and may be used for various purposes. For example, the memory device 76 may store processor-executable instructions (e.g., firmware or software) for the processor 74 to execute, such as instructions for providing commands and/or data to the vehicle controller 50.

In the illustrated embodiment, the base station 40 includes a user interface 78 communicatively coupled to the base station controller 72. The user interface 78 is configured to present data from one or more work vehicles to an operator (e.g., data associated with objects surrounding the work vehicle(s), data associated with the types of the objects surrounding the work vehicle(s), data associated with operation of the work vehicle(s), data associated with the plan(s) of the work vehicle(s), etc.). The user interface 78 may also enable the user to input information about the work area and/or the plan that may enable the base station controller 72 to determine further courses of action for the work vehicle. The user interface 78 is also configured to enable an operator to control certain functions of the work vehicle(s) (e.g., starting and stopping the work vehicle(s), instructing the work vehicle(s) to follow route(s) through the work area, etc.). In the illustrated embodiment, the user interface 78 includes a display 80 configured to present information to the operator, such as the position of the work vehicle(s) within the work area, the speed of the work vehicle(s), and the path(s) of the work vehicle(s), among other data. The display 80 may be configured to receive touch inputs, and/or the user interface 78 may include other input device(s), such as a keyboard, mouse, or other human-to-machine input device(s). In addition, the user interface 78 (e.g., via the display 80, via an audio system, etc.) may be configured to notify the operator of the plan and travel path of the work vehicle.

In the illustrated embodiment, the base station 40 includes a storage device 82 communicatively coupled to the base station controller 72. The storage device 82 (e.g., nonvolatile storage) may include ROM, flash memory, a hard drive, or any other suitable optical, magnetic, or solid-state storage medium, or a combination thereof. The storage device(s) may store data (e.g., work area maps), instructions (e.g., software or firmware for commanding the work vehicle(s), etc.), and any other suitable data.

While the vehicle control system 26 of the control system 34 includes the vehicle controller 50 in the illustrated embodiment, it should be appreciated that in alternative embodiments, the vehicle control system 26 may include the base station controller 72. For example, in certain embodiments, control functions of the vehicle control system 26 may be distributed between the vehicle controller 50 and the base station controller 72. In further embodiments, the base station controller 72 may perform a substantial portion of the control functions of the vehicle control system 26. Indeed, any processes of the vehicle controller 50 and the base station controller 72 may be allocated to either controller in at least some embodiments. Furthermore, at least part of the processes described herein may be performed via a cloud-based service or other remote computing, and such computing is considered part of the vehicle control system 26.

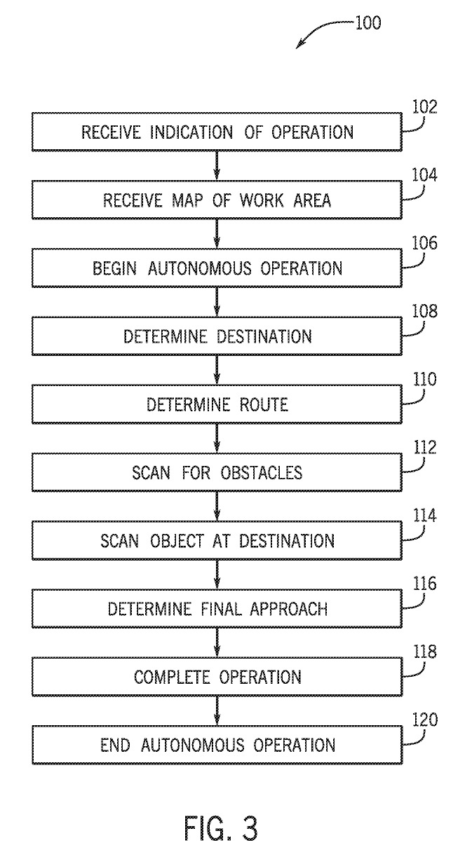

FIG. 3 is a flowchart of an embodiment of a process 100 for autonomously controlling the work vehicle. The process 100 enables the work vehicle to autonomously complete tasks associated with objects in the work area. Although the following process 100 includes a number of operations that may be performed, it should be noted that the process 100 may be performed in a variety of suitable orders (e.g., the order that the operations are discussed, or any other suitable order). All of the operations of the process 100 may not be performed. Further, all of the operations of the process 100 may be performed by the vehicle controller, the base station controller, or a combination thereof.

The vehicle controller is configured to receive (block 102) an indication of the operation (i.e., part of a plan) to be performed. The indication may be sent by an operator or the indication may be sent automatically. For example, as another operation is completed, an indication of another operation may be automatically sent. Further, in some embodiments if a certain condition is met (e.g., a consumable such as, fuel, fertilizer, seed, etc. falls below a certain threshold), an indication of an operation may be automatically sent. The indication may be indicative of any suitable operation, such as parking in a stall, coupling to an attachment, coupling to a nurse truck, offloading material into a material receptacle, or any other autonomous or semi-autonomous operation. Further, in some embodiments, the operation may not be received, but the vehicle controller may begin an operation in response to a plan, in response to a low consumable level, etc.

Next, the controller receives (block 104) a map of the work area. The map may include the location and dimensions (e.g., size, shape, etc.) of objects contained within the work area. As discussed above, the map may be created by an operator, generated by scanning the work area with a sensor assembly during a prior pass, by a scout vehicle, etc. Further, the map may be updated by work vehicles with one or more sensors as the work vehicle(s) travel through the work area. Further, the objects contained within the map may include identifiers (e.g., metadata) indicating what the object is. For example, a stall may be identified as a stall on the map (e.g., by an operator or automatically from a previous operation).

After receiving (block 102) an indication of an operation, the controller may begin (block 106) autonomous or semi-autonomous operation of the work vehicle, during which the controller may determine subsequent actions such as creating a plan to perform an operation. In autonomously operating the work vehicle, the controller controls some or all of the movements of the work vehicle. For example, during full autonomous control, the controller controls all of the movements of the work vehicle, and, in some embodiments, the operator may not be present inside the work vehicle. Further, during semi-autonomous control, the controller may control a portion of the movements of the work vehicle.

Then, the controller determines (block 108) a destination. Utilizing the map, the controller may determine a destination based on the indication of the operation to be performed. For example, for parking in a stall, the stall identified on the map is the target destination. Further, for coupling to an attachment or nurse truck, the respective attachment or nurse truck is the target destination. For offloading material into a material receptacle, the material receptacle is the target destination. Further, the controller may determine the current location of the work vehicle. The current location may be determined by operator input, a signal received from the spatial locating device, or determined based on a previous location and telemetry data (e.g., speed and direction).

After the destination is determined, the controller determines (block 110) a route from the current location of the work vehicle to the location of the target destination. The determined route may be based upon several factors, such as time to completion of the route, ability for work vehicle to avoid obstacles along the route based upon the physical characteristics of the work vehicle (e.g., width, turning radius, etc.), orientation of work vehicle upon reaching the destination (e.g., ensuring the rear of the work vehicle is facing an attachment), etc. Further, the determined route may be based upon limitation implemented by the first obstacle avoidance system, the second obstacle avoidance system, or a combination thereof. For example, the determined route may maintain at least a minimum distance between obstacles in the work area and the work vehicle. In some embodiments, there may be multiple objects with the same identifier. In such embodiments, an operator may select which object should serve as the destination, or the controller may automatically select the object (e.g., based on a previous selection by an operator, distance of the object from the work vehicle, etc.).

While travelling along the planned route, a sensor assembly may scan (block 112) for obstacles along the path. The received (block 104) map may not include every obstacle that is present in the work area, or obstacles may move in the work area. Thus, the sensor assembly scans the path ahead of the work vehicle for obstacles that may be present in the work area. The sensor assembly sends a signal to the controller which may determine an obstacle is present in the work area that is not present in the map, or the obstacle is not where the map shows the obstacle. The controller may then update the map to include the new or moved obstacle. Further, if an obstacle is included in the map, but not detected in the work area, the controller may remove the obstacle from the map, or the controller may notify an operator who may choose to remove the obstacle from the map, or let the obstacle remain on the map. If the obstacle is along the path of the work vehicle, the controller, the first obstacle avoidance system, or a combination thereof may update the route of the work vehicle to maintain a minimum distance between the obstacle and the work vehicle.

Once the work vehicle approaches the destination, the sensor assembly scans (block 114) the object at the destination and sends a signal (e.g., a signal from infrared sensors, ultrasonic sensors, magnetic sensors, radar sensors, Lidar sensors, terahertz sensors, etc.) indicative of the object to the controller. From this signal, the controller may determine more specific information about the object, such as its dimensions, what type of object is present at the destination, whether the object present at the destination matches the object that is the subject of the operation, etc.

As discussed above, the type of operation may include coupling to an attachment, parking in a stall, coupling to a nurse vehicle, etc. For example, when the operation is coupling to an attachment, the sensor assembly scans the attachment. Scanning the attachment enables the controller to determine the precise location of the attachment, and the portion of the attachment used for coupling to the work vehicle. For example, the attachment may have moved slightly since the attachment was added to the map, the map may not include objects with a sufficient tolerance for docking, etc. Thus, scanning the attachment enables the controller to determine, in real time or near real time, the location of the attachment, and the location of the portion of the attachment used for coupling.

For example, when the operation is parking in the stall, the sensor assembly scans the stall. As discussed above, the first obstacle avoidance system may be utilized to maintain a certain minimum distance between the work vehicle and other objects. However, it may be desirable to park the work vehicle closer to a wall of the stall than the minimum distance maintained by the obstacle avoidance system. Thus, the second obstacle avoidance system may be utilized in conjunction with the sensor assembly to enable the work vehicle to move closer to the stall than the minimum distance maintained by the first obstacle avoidance system. For example, if part of the operation includes contacting an object, the first obstacle avoidance system may be partially or fully disabled as the work vehicle approaches the object. Further, scanning the stall enables the controller to identify obstacles inside the stall that may interfere with the parking of the work vehicle. If the controller determines there is an obstacle that may interfere with the parking of the work vehicle, the controller may send a signal (e.g., to the base station controller, to the operator, etc.) indicative of an obstacle preventing the operation from being completed. In some embodiments, there may be multiple spots that the work vehicle may park. In such embodiments, the controller may direct the work vehicle to another suitable spot. Further, the sensor assembly may enable the controller to determine a specified location within the stall that is the target parking location.

Next, the controller determines (block 116) a final approach to the object and completes (block 118) the operation. For example, in determining a final approach for coupling to an attachment, the controller prepares the work vehicle for coupling with the attachment. Different attachments may include different types of couplings, which may affect how the controller prepares the work vehicle for coupling. For example, some attachments may couple automatically by moving the work vehicle into contact with the attachment. Other attachments may utilize an operator to manually complete the coupling after the work vehicle has moved into position. In still further attachments, the controller may activate an automatic actuation of a locking mechanism to couple to the attachment. The type of coupling may be associated with the type of attachment in the map, identified by the sensor assembly, specified by an operator, or saved from a previous operation.

Further, in some embodiments, the object may include a material in the material stall. In such embodiments, the work vehicle may approach the material in order to receive the material from the material stall. For example, some material stalls may include the material suspended in the air, and a release mechanism that drops the material downward. In such material stalls, the work vehicle may be positioned below the suspended material. In other embodiments, the material may be disposed on the ground, and the work vehicle may approach the material to either receive the material from a different machine, or the work vehicle may be configured to pick up the material itself. Further, in some embodiments the work vehicle may approach the material stall to offload material. In such embodiments, the work vehicle may approach a certain position within the material stall and offload the material into the determined position.

Further, in determining a final approach for parking in a stall, the controller determines a final path for the work vehicle to park inside of the stall. While completing the final path, the controller may maintain, based on a signal from the sensor assembly, at least a certain threshold distance between the work vehicle and the structure of the stall.

Further, in determining a final approach for coupling to the nurse truck, the controller prepares the work vehicle for coupling with the nurse truck. Different nurse trucks may include different types of couplings. Further, different nurse trucks may include the couplings at different locations. Thus, preparing the work vehicle for filling may include maneuvering the work vehicle to a location that enables the work vehicle to couple to the nurse truck at a target location. Preparing the work vehicle for filling may also include maintaining at least a certain distance between the work vehicle and the nurse truck.

Further, in determining a final approach for offloading material into a material receptacle, the controller prepares the work vehicle for offloading material. Different material receptacles may have different heights and/or different offloading points. Thus, preparing the work vehicle for offloading may include maneuvering the work vehicle to a location that enables the work vehicle to offload material into the material receptacle. For example, the area in which the separate vehicle may receive the material (e.g., a bed of a vehicle) may be rectangular shaped. Thus, preparing the work vehicle for offloading may include identifying which side of the material receptacle is longer, and approaching the longer side orthogonally. Preparing the work vehicle for offloading may also include lifting a portion of the work vehicle (e.g., a front loader). Preparing the work vehicle for offloading may also include maintaining at least a certain distance between the work vehicle and the material receptacle. Preparing the work vehicle for offloading may also include sensing, via the sensor assembly, material already contained within the material receptacle, which may enable the controller to direct the work vehicle to offload the material into the material receptacle to evenly distribute the material within the material receptacle, such that the material in the material receptacle has a substantially even level.

Next, the controller carries out the determined final approach to complete (block 118) the operation. After completing the operation, an operator may end the autonomous operation by sending a signal to the controller, or the controller may automatically determine that the operation is complete. Upon receiving a signal of completion of the operation, the controller ends (block 120) the autonomous operation.

While only certain features of the disclosure have been illustrated and described herein, many modifications and changes will occur to those skilled in the art. It is, therefore, to be understood that the appended claims are intended to cover all such modifications and changes as fall within the true spirit of the disclosure.

1. A control system of a work vehicle system comprising:
a controller comprising a memory and a processor, wherein the controller is configured to:
determine a route from a current location of a work vehicle to a destination based, at least in part, on a map of a work area;
output one or more control instructions indicative of a travel path for the work vehicle from the current location to a target object at the destination;
determine whether the route includes one or more obstacles not included on the map of the work area based, at least in part, on a first signal received from a sensor assembly; and
determine a final approach to a target location near or at the target object at the destination based, at least in part, on a second signal received from the sensor assembly.

2. The control system of claim 1, wherein the controller is configured to determine the destination based, at least in part, on a third signal indicative of a type of operation.

3. The control system of claim 2, wherein the controller is configured to determine dimensions of the target object at the destination based, at least in part, on a fourth signal received from the sensor assembly.

4. The control system of claim 3, wherein the controller is configured to determine whether the target object at the destination matches a desired object based, at least in part, on the type of operation.

5. The control system of claim 1, wherein determining the final approach is based, at least in part, on a type of the target object.

6. The control system of claim 1, wherein determining the route is based, at least in part, on maintaining at least a minimum distance between the work vehicle and one or more obstacles disposed in the work area.

7. The control system of claim 1, wherein the controller is configured to begin an autonomous operation of the work vehicle upon receiving a fifth signal indicative of a type of operation.

8. The control system of claim 7, wherein the controller is configured to end the autonomous operation of the work vehicle upon receiving a sixth signal indicative of completing an operation.

9. A method for autonomously controlling a work vehicle comprising:
determining, via a controller, a route from a current location of a work vehicle to a destination based, at least in part, on a map of a work area;
outputting, via the controller, one or more control instructions indicative of a travel path for the work vehicle from the current location to a target object at the destination;
determining, via the controller, whether the route includes one or more obstacles not included on the map of the work area based, at least in part, on a first signal received from a sensor assembly; and
determining, via the controller, a final approach to a target location near or at the target object at the destination based, at least in part, on a second signal received from the sensor assembly.

10. The method of claim 9, comprising determining, via the controller, the destination based, at least in part, on a third signal indicative of a type of operation.

11. The method of claim 10, comprising determining, via the controller, dimensions of the target object at the destination based, at least in part, on a fourth signal received from the sensor assembly.

12. The method of claim 11, comprising determining, via the controller, whether the target object at the destination matches a desired object based, at least in part, on the type of operation.

13. The method of claim 9, wherein determining the final approach is based, at least in part, on a type of the target object.

14. The method of claim 9, wherein determining the route is based, at least in part, on maintaining at least a minimum distance between the work vehicle and one or more obstacles disposed in the work area.

15. The method of claim 9, comprising beginning, via the controller, an autonomous operation of the work vehicle upon receiving a fifth signal indicative of a type of operation.

16. The method of claim 15, comprising ending, via the controller, the autonomous operation of the work vehicle upon receiving a sixth signal indicative of completing an operation

17. One or more tangible, non-transitory, machine-readable media comprising instructions configured to cause a processor to:
determine a route from a current location of a work vehicle to a destination based, at least in part, on a map of a work area;
output one or more control instructions indicative of a travel path for the work vehicle from the current location to a target object at the destination;
determine whether the route includes one or more obstacles not included on the map of the work area based, at least in part, on a first signal received from a sensor assembly;
determine a final approach to a target location near or at the target object at the destination based, at least in part, on a second signal received from the sensor assembly.

18. The one or more tangible, non-transitory, machine-readable media comprising instructions of claim 17, wherein the instructions are configured to cause the processor to determine the destination based, at least in part, on a third signal indicative of a type of operation.

19. The one or more tangible, non-transitory, machine-readable media comprising instructions of claim 18, wherein the instructions are configured to cause the processor to determine dimensions of the target object at the destination based, at least in part, on a fourth signal received from the sensor assembly.

20. The one or more tangible, non-transitory, machine-readable media comprising instructions of claim 17, wherein the instructions are configured to cause the processor to determine whether the target object at the destination matches a desired object based, at least in part, on the type of operation.
